(19) United States
(12) Patent Application Publication
(10) Pub. No.: US 2012/0173854 A1
(43) Pub. Date: Jul. 5, 2012

(54) PROCESSOR HAVING INCREASED EFFECTIVE PHYSICAL FILE SIZE VIA REGISTER MAPPING

(75) Inventors: Jay FLEISCHMAN, Ft. Collins, CO (US); Debjit Das Sarma, San Jose, CA (US); Michael SEDMAK, Ft. Collins, CO (US)

(73) Assignee: ADVANCED MICRO DEVICES, INC., Sunnyvale, CA (US)

(21) Appl. No.: 12/980,860

(22) Filed: Dec. 29, 2010

(51) Int. Cl. G06F 9/302

(52) U.S. Cl. 712/222; 712/220; 712/E09.025; 712/E09.017

(57) ABSTRACT

Methods and apparatuses are provided for an efficient technique for processing registers having a known value while improving processor performance. The apparatus comprises a processor having a plurality of physical registers available for use in computations and a decoder for determining that a logical register contains a known value. A renaming unit maps the logical register containing the known value to an address outside an address range for the plurality of physical registers once the known value is determined. Thereafter, scheduling and execution units perform computations using the known value without storing the known value in one of the plurality of physical registers. The method comprises determining that a logical register of a processor has a known value and then mapping that logical register to a physical register address outside an expected range of physical register addresses; which indicates that the logical register represents the known value. Thereafter the processor processes any instruction using the known value without storing the known value in a physical register.

### FIELD OF THE INVENTION

The present invention relates to the field of information or data processing. More specifically, this invention relates to the field of implementing a computational or mathematical unit in a processor achieving an increased effective physical file size and physical register reuse via register mapping techniques.

### BACKGROUND

Information or data processors are found in many contemporary electronic devices such as, for example, personal computers, personal digital assistants, game playing devices, video equipment and cellular phones. Processors used in today's most popular products are known as hardware as they comprise one or more integrated circuits. Processors execute software to implement various functions in any processor based device. Generally, software is written in a form known as source code that is compiled (by a complier) into object code. Object code within a processor is implemented to achieve a defined set of assembly language instructions that are executed by the processor using the processor's instruction set. An instruction set defines instructions that a processor can execute. Instructions include arithmetic instructions (e.g., add and subtract), logic instructions (e.g., AND, OR, and NOT instructions), and data instructions (e.g., move, input, output, load, and store instructions). As is known, computers with different architectures can share a common instruction set. For example, processors from different manufacturers may implement nearly identical versions of an instruction set (e.g., an x86 instruction set), but have substantially different architectural designs.

Within a processor, numerical data is typically expressed using integer or floating-point representation. Mathematical computations within a processor are generally performed in computational units designed for maximum efficiency for each computation. Thus, it is common for a processor architecture to have an integer computational unit and a floating-point computational unit. As the use of graphic processing and scientific computing has expanded, the use of a processor's integer and floating-point mathematical capabilities has been increasing. Other factors, such as use for audio processing, are also contributing to an increased use of a processor's mathematical capabilities. To accommodate these and other needs, and to meet the ever growing demand for increased integer and floating-point performance, the computational capability of processors is continually evolving.

In any processor architecture, there exists a limited number of physical registers for storing instructions and data. Typically, an integer computation unit and floating-point computational unit will have its own set of physical registers available. However, in either computational unit, once committed, a physical register is unable to be used again until the completion of the instruction or until the data has been processed and sent to another storage location. At that time, the physical register becomes available and is added to a “free list” of available registers for reassignment. The longer a physical register remains unavailable, the more performance may suffer. This is particularly true if a data value is known, as storing a known value in a physical register for the duration of the instruction processing is wasteful of the limited resources. Moreover, moving a known value from one register to another register wastes operational cycles of the processor and consumes power.

### BRIEF SUMMARY OF EMBODIMENTS OF THE INVENTION

An apparatus is provided for an efficient technique for processing known register values while improving processor performance. The apparatus comprises a processor having a plurality of physical registers available for use in computations and a decoder for determining that a logical register contains a known value. A renaming unit maps the logical register containing the known value to an address outside an address range for the plurality of physical registers once the known value is determined. Thereafter, scheduling and execution units perform computations using the known value without storing the known value in one of the plurality of physical registers.

An apparatus is also provided for an efficient technique for processing registers having a zero value while improving processor performance. The apparatus comprises a processor having a plurality of physical registers available for use in computations and a decoder for determining that a logical register contains a zero value. A renaming unit maps the logical register containing the zero value to an address outside an address range for the plurality of physical registers once the known value is determined. Thereafter, scheduling and execution units perform computations using the zero value without storing the zero value in one of the plurality of physical registers.

A method is provided for an efficient technique for processing known register values while improving processor performance. The method comprises determining that a logical register of a processor has a known value and then mapping that logical register to a physical register address outside an expected range of physical register addresses; which indicates that the logical register represents the known value. Thereafter the processor processes any instruction using the known value without storing the known value in a physical register.

A method is also provided for an efficient technique for processing register having a zero values while improving processor performance. The method comprises determining that a logical register of a processor has a zero value and then mapping that logical register to a physical register address outside an expected range of physical register addresses; which indicates that that the logical register represents the zero value. Thereafter the processor processes any instruction using the zero value without storing the zero value in a physical register.

### BRIEF DESCRIPTION OF THE DRAWINGS

The present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of computational unit suitable for use with the processor of FIG. 1;

FIG. 3 is a diagram illustrating physical register renaming according to an embodiment of the present disclosure; and

FIG. 4 is a flow diagram illustrating physical register renaming according to an embodiment of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

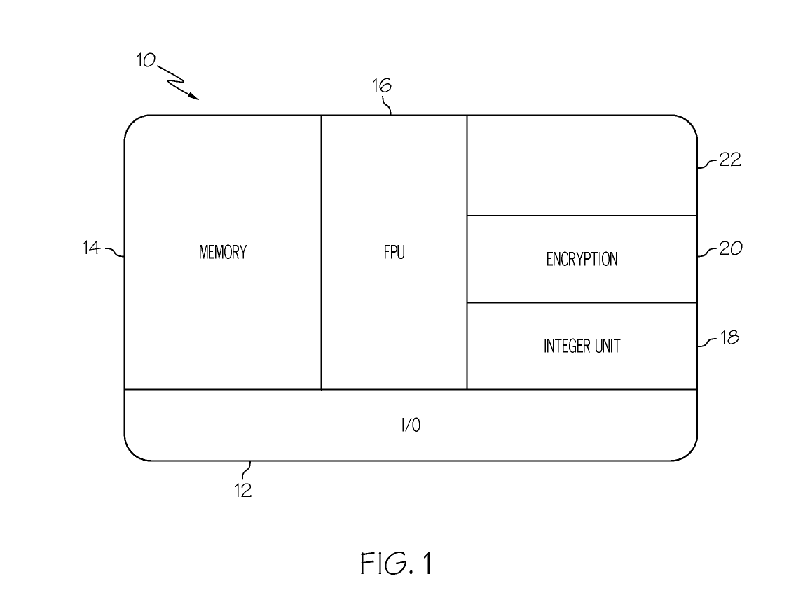

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Additionally, an encryption unit 20 and various other types of units (generally 22) as desired for any particular processor microarchitecture may be included.

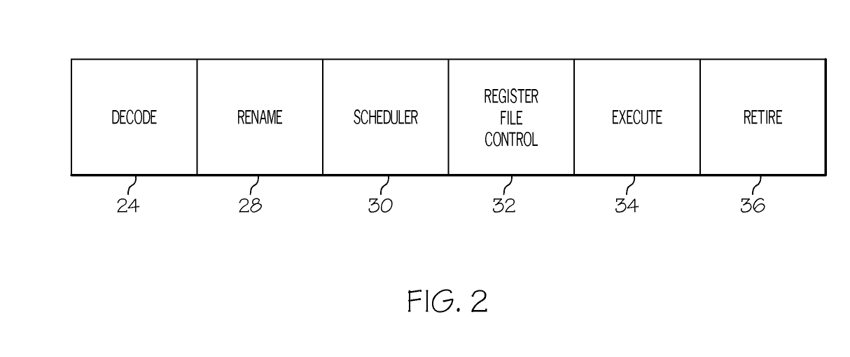

Referring now to FIG. 2, a simplified exemplary block diagram of a computational unit suitable for use with the processor 10. In one embodiment, FIG. 2 could operate as the floating-point unit 16, while in other embodiments FIG. 2 could illustrate the integer unit 18.

In operation, the decode unit 24 decodes the incoming operation-codes (opcodes) to be dispatched for the computations or processing. The decode unit 24 is responsible for the general decoding of instructions (e.g., x86 instructions and extensions thereof) and how the delivered opcodes may change from the instruction. The decode unit 24 will also pass on physical register numbers (PRNs) from a available list of PRNs (often referred to as the Free List (FL)) to the rename unit 28.

The rename unit 28 maps logical register numbers (LRNs) to the physical register numbers (PRNs) prior to scheduling and execution. According to various embodiments of the present disclosure, the rename unit 28 can be utilized to rename or remap logical registers in a manner that eliminates the need to store known data values in a physical register. In one embodiment, this is implemented with a register mapping table stored in the rename unit 28. According to the present disclosure, renaming or remapping registers saves operational cycles and power, as well as decreases latency.

The scheduler 30 contains a scheduler queue and associated issue logic. As its name implies, the scheduler 30 is responsible for determining which opcodes are passed to execution units and in what order. In one embodiment, the scheduler 30 accepts renamed opcodes from rename unit 28 and stores them in the scheduler 30 until they are eligible to be selected by the scheduler to issue to one of the execution pipes.

The register file control 32 holds the physical registers. The physical register numbers and their associated valid bits arrive from the scheduler 30. Source operands are read out of the physical registers and results written back into the physical registers. In one embodiment, the register file control 32 also check for parity errors on all operands before the opcodes are delivered to the execution units. In a multi-pipelined (super-scalar) architecture, an opcode (with any data) would be issued for each execution pipe.

The execute unit(s) 34 may be embodied as any generation purpose or specialized execution architecture as desired for a particular processor. In one embodiment the execution unit may be realized as a single instruction multiple data (SIMD) arithmetic logic unit (ALU). In another embodiment, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 36 maintains an in-order list of all opcodes in process in the floating-point unit 16 (or integer unit 18 as the case may be) that have passed the rename 28 stage and have not yet been committed by to the architectural state. The retire unit 36 is responsible for committing all the floating-point unit 16 or integer unit 18 architectural states upon retirement of an opcode.

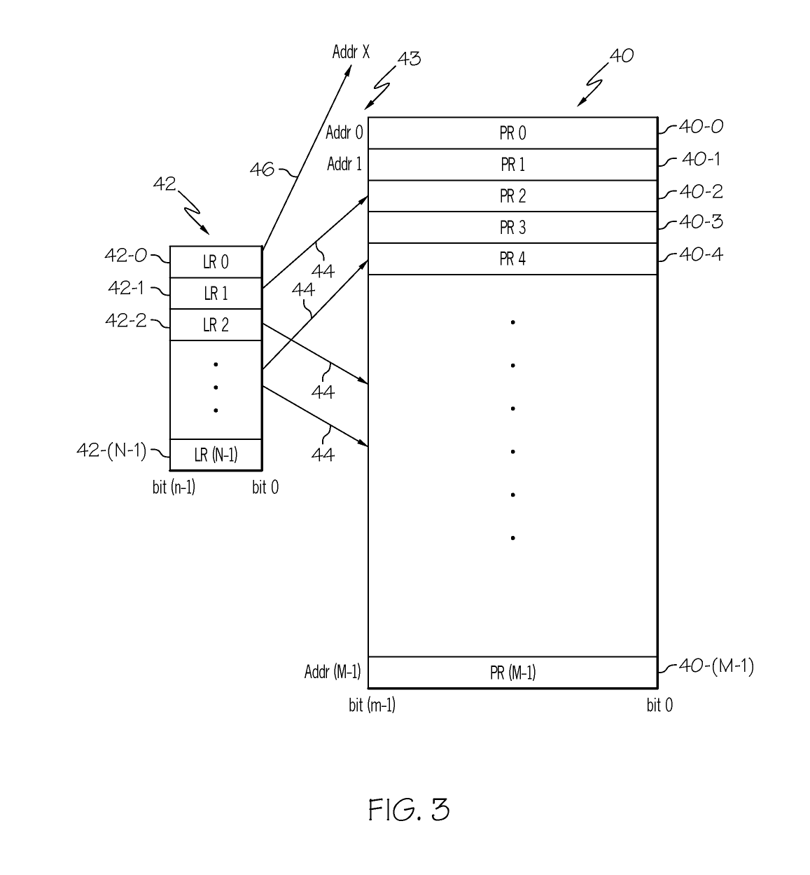

Referring now to FIG. 3, there is shown an illustration of physical registers 40 available for use during execution of an instruction (be it floating-point or integer). In one embodiment, the physical registers 40 reside in the register file control unit (32 in FIG. 2) and are organized in one or more address blocks for reading and writing operations. The various physical registers, 40-0, 40-2, 40-3 through 40-(M−1), are limited in number and are committed to a particular use for so long as necessary for the performance of an instruction. The physical registers 30 are known as “wide” registers as they contain a large number of bits (bit 0 through bit (m−1)), which in various embodiments may be 64 bits, 128 bits or 256 bits. At the conclusion (retirement) of the instruction, any available physical registers (such as those reclaimed from old, now obsolete mappings) are returned to a “free list” indicating that they are available for use by another instruction. Each physical register, 40-0, 40-2, 40-3 through 40-(M−1), has an address (generally 43) that resides in an expected range of addresses (Addr 0, Addr 2 through Addr (M−1)) known to be associated with the physical registers 40.

Also illustrated in FIG. 3 is a register mapping table 42, which contains the mapping of the physical registers 40 to logical registers. Logical registers are architected registers and may reside or be distributed through the processor 10 (or computational unit 16 or 18) as desired in any particular architecture. In one embodiment, the register mapping table 42 resides in the rename unit (28 in FIG. 2) so that the mappings of architected or logical register to the physical registers 40 can be changed by renaming or changing the mapping as will be more completely described below. In the register mapping table 42, the registers 42-0 through 42-(N−1) are known as “narrow” registers as they have few bits compared to the physical registers 40. Generally, the value N (the number of registers) of the register mapping table 42 corresponds to the number of logical registers and have a sufficient number of bits (n) to map (or point to) the complete address range 43 of the physical registers 40. For example, if n=8, then the register mapping table 42 could point to 256 physical registers (in binary). In another embodiment, the register mapping table 42 also contains additional bits (not shown) that can be used as indicators a logical register contains a known value or zero value. In this embodiment, remapping the address would not be required. Rather, one or more of the additional bits could be set to indicate a known or zero value in the associated logical register.

As illustrated in FIG. 3, the register mapping table 42 has mapped several logical registers to various physical registers as illustrated generally by arrows 44. For example, the logical register associated with LR1 (42-1) is mapped to physical register PR2 (40-2), and so on. For the remapping embodiment, consider now that one of the logical registers, for example the logical register associated with LR 0 (42-0), is determined to be of a known value. Storing the known value in a physical register for the duration of the instruction is wasteful of resources as the physical registers 40 are limited in number. Moreover, every operation generating a new value for any logical register generally requires commitment of one of the limited number of physical registers 40, thus further reducing the number of physical registers available for use. According to one embodiment of the disclosure, register LR0 (42-0) is remapped or renamed to an address (Addr X) outside the expected range of addresses 43 of the physical registers 40 (as illustrated by arrow 46). Alternately, register LR0 (42-0) is remapped or renamed to any predetermined address that is reserved to indicated the known (or zero) value. Thus, mapping or renaming of the LR0 of the register mapping table 42 indicates to the processor 10 (or a computational unit depending upon the embodiment implemented) that the known value can be used in any instruction calling for the logical register associated with LR 0 (42-0), thus making the logical register a virtual register and not requiring a known value to be stored in any physical register 40. Thus, the previous physical register mapped to LR0 (prior mapping not shown) can be returned to the free list well in advance of the instruction being completed, and with no new physical register being committed, thereby effectively increasing the number of physical registers 40 available to be reassigned to other instructions.

For the register mapping table 42 bit setting embodiment, consider again that one of the logical registers, for example the logical register associated with LR 0 (42-0), is determined to be of a known value. In this embodiment, the register mapping table 42 includes additional bits (beyond that needed to address the physical register address space) that can be set to indicate a known value. Thus, regardless of the logical register mapping, one or more of these additional bits can be set to indicate the known that a know value is associated with that logical register.

In one embodiment, the known value is zero, which occurs frequently during floating-point or integer computations. However, any known value that finds frequent use in any implementation of any processor architecture may be used following the teachings of the present disclosure and are within the scope of the present disclosure.

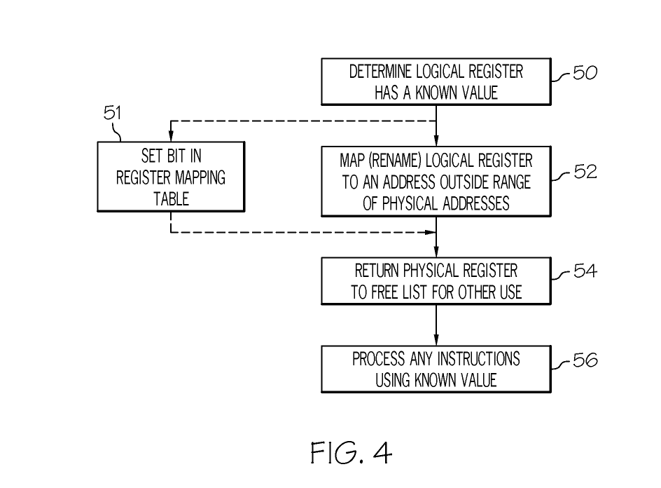

Referring now to FIG. 4, a flow diagram is shown illustrating the steps followed by various embodiments of the present disclosure for the processor 10, the floating-point unit 16, the integer unit 18 or any other unit 22 of the processor 10 that performs functions using a limited number of physical registers. In step 50, a determination is made that a physical register has a known value. In one embodiment, this is determined in the decode stage 24 (see FIG. 2), however, the determination can be made at any convenient location. The determination can be made in any convenient way, such as the nature of the instruction to be performed. For example, the instruction A*(B−0)/C requires that a value zero be subtracted from the value (unknown) of variable B. Rather than store a zero value in a physical register until the subtraction step is performed, register 42-0 (see FIG. 3) that would map the zero value logical register to a physical register having to store the zero value is mapped (renamed) to an address (Addr X—see FIG. 3) outside the expected range of physical addresses (step 52) or to a predetermined address. In another embodiment, regardless of the logical-to-physical register mapping, a bit is set (step 51) in the register mapping table (42 in FIG. 3) to indicate the known value as discussed above.

Next, at step 54, the physical register previously mapped to the register mapping table (prior mapping not shown) can be returned to the free list to be made available for other instructions. Finally, at execution time, any instructions (in this example B−0) using the known value would simply insert that value (zero) at the proper time to have the instruction competed. In this way, physical registers can be made available much more rapidly than in previous processor or floating-point architectures. Also, there was no need to move the zero value through the bus or the remaining sections of the processor (or computational units 16 or 18—see FIG. 2) as the known value is simply injected at the point needed to perform the instruction. This saves both operational cycles and power consumption by not wasting time and energy reading and moving a zero value.

Various processor-based devices may advantageously use the processor (or computational unit) of the present disclosure, including laptop computers, digital books, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or computational unit) of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising the steps of:
determining that a logical register of a processor has a known value;
mapping the logical register to a physical register address outside an expected range of physical register addresses to indicate that the logical register represents the known value.

2. The method of claim 1, which includes the step of making the physical register available for further use following the mapping step.

3. The method of claim 1, wherein the determining step further comprises determining that the logical register of the processor has a known value of zero.

4. The method of claim 3, wherein the processing step further comprises processing the instruction using the known value of zero without continuing to store the known value of zero in the physical register.

5. The method of claim 1, wherein the processing step further comprises:
scheduling an instruction for execution by an execution unit;
executing the instruction; and
retiring the instruction.

6. The method of claim 1, wherein the processing step further comprises processing floating-point instructions within a floating-point unit of the processor.

7. The method of claim 1, wherein the processing step further comprises processing integer instructions within an integer unit of the processor.

8. A method, comprising the steps of:
determining that a logical register of a processor has a known value;
setting a bit associated with the logical register to indicate that the logical register has the known value;
processing instructions calling for the logical register using the known value without reading the known value from a physical register.

9. The method of claim 8, which includes the step of making the physical register available for further use following the setting step.

10. The method of claim 8, wherein the determining step further comprises determining that the logical register of the processor has a known value of zero.

11. A processor comprising:
a plurality of physical registers available for use in computations;
a renaming unit for mapping a logical register determined to contain a known value to an address outside an address range for the plurality of physical registers; and
scheduling and execution units for performing computations using the known value without storing the known value in one of the plurality of physical registers.

12. The processor of claim 11, wherein the known value is zero.

13. The processor of claim 11, which includes an integer computational unit for performing integer computations using the known value.

14. The processor of claim 11, which includes a floating-point computational unit for performing floating-point computations using the known value.

15. The processor of claim 11, which includes other circuitry to implement one of the group of processor-based devices consisting of: a computer; a digital book; a printer; a scanner; a television or a set-top box.

16. A processor, comprising:
a plurality of physical registers available for use in computations;
a table having at least one bit associated with a logical register determined to contain a known value; and
scheduling and execution units for performing computations using the known value without storing the known value in one of the plurality of physical registers.

17. The processor of claim 16, which includes a floating-point computational unit for performing floating-point computations.

18. The processor of claim 16, which includes an integer computational unit for performing integer computations.

19. The processor having a computational unit of claim 16, wherein the known value is zero.

20. The processor of claim 16, wherein the processor also makes one of the plurality of physical registers available for use in other instructions after setting the at least one bit of the table associated with the logical register containing the known value.

21. The processor of claim 16, which includes other circuitry to implement one of the group of processor-based devices consisting of: a computer; a digital book; a printer; a scanner; a television or a set-top box.
